(19) United States
(12) Patent Application Publication
(10) Pub. No.: US 2008/0216818 A1
(43) Pub. Date: Sep. 11, 2008

(54) FIREPLACE INSTALLATION WITH SOUND SYSTEM

(75) Inventors: Kurt W.F. Rumens, Kirkland, WA (US); Alan R. Atemboski, Renton, WA (US)

Correspondence Address: PERKINS COIE LLP;PATENT-SEA, P.O. BOX 1247, SEATTLE, WA, 98111-1247, US

(73) Assignee: Travis Industries, Inc., Mukilteo, WA (US)

(21) Appl. No.: 11/684,545

(22) Filed: Mar. 9, 2007

(51) Int. Cl. F24B 1/18; G09F 19/00

(52) U.S. Cl. 126/500; 40/428

(57) ABSTRACT

A fireplace installation is disclosed herein. In one embodiment, a fireplace installation includes a fireplace installation accessory having a recess and a fireplace unit positioned in the recess. The fireplace installation also includes a sound system positioned within the fireplace installation. The sound system includes an amplifier, one or more speakers, and a connector for connecting to a music player.

### TECHNICAL FIELD

The present invention is directed to fireplace installations and associated components for the installations.

### SUMMARY

The present invention overcomes limitations of the prior art and provides additional benefits. A brief summary of certain embodiments and aspects of the invention is presented. Thereafter, a detailed description of the illustrated embodiments is presented, which will permit one skilled in the relevant art to understand, make, and use aspects of the invention. One skilled in the art can obtain a full appreciation of aspects of the invention from the subsequent detailed description, read together with the figures, and from the claims, which follow the detailed description.

Under one aspect of the invention, a fireplace installation is provided that includes a sound system. The fireplace installation includes a fireplace installation accessory having an opening to receive a fireplace unit positioned in the opening. The sound system is integrally connected to at least one of the fireplace installation accessory and the fireplace unit. The sound system includes at least an amplifier, one or more speakers, and a connector for connecting to a music player.

In another embodiment, a fireplace installation includes a fireplace installation housing and a fireplace unit. The fireplace unit is positioned in the fireplace installation housing and an electrical source is connected to the fireplace unit. The fireplace installation also includes a sound system integrally connected to at least one of the fireplace installation housing and the fireplace unit. The sound system is at least partially concealed. The sound system is powered by the fireplace unit and includes at least an amplifier, one or more speakers, and a music player connector.

### BRIEF DESCRIPTION OF THE DRAWINGS

FIG. 1 is a front elevation view of a fireplace installation in accordance with an embodiment of the invention.

FIG. 2 is a front elevation view of a fireplace installation in accordance with another embodiment of the invention.

FIG. 3 is an exploded, partial front isometric view of a fireplace unit and a fireplace installation accessory according to an embodiment of the invention.

FIG. 4 is an isometric view of a fireplace installation in accordance with another embodiment of the invention.

### DETAILED DESCRIPTION

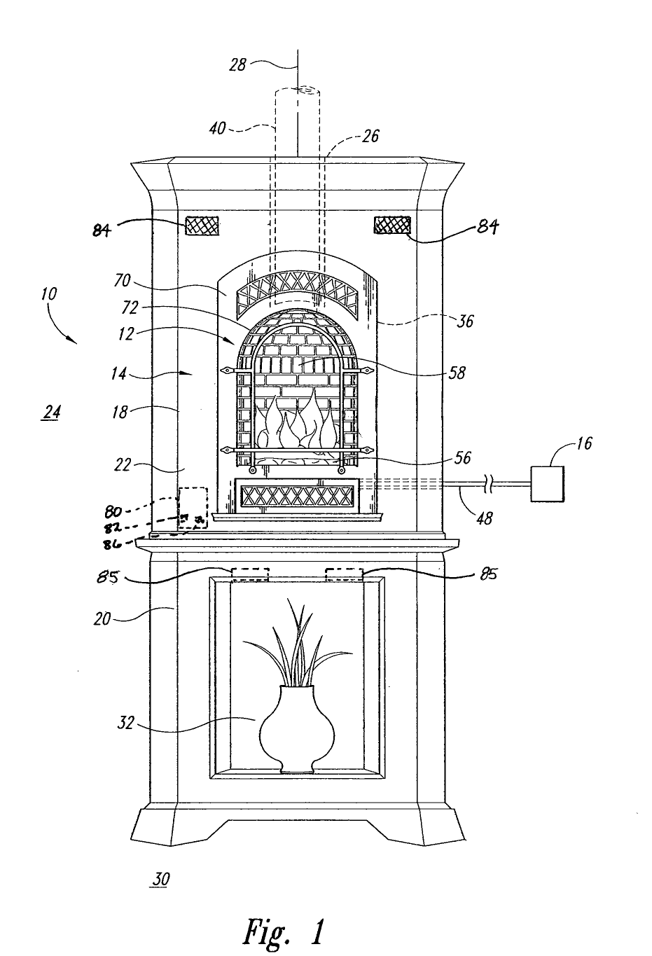

Specific details of several embodiments of fireplace installations having sound systems are described below to provide a thorough and enabling description for embodiments of the invention. However, several details describing well-known structures or processes often associated with fireplace assemblies are not included in the following description for purposes of brevity and clarity. Also, several other embodiments of the invention can have different configurations, components, or procedures than those described in this section. A person of ordinary skill in the art, therefore, will understand that the invention may have other embodiments with additional elements, or that the invention may have other embodiments without several of the elements shown and described below with reference to FIGS. 1-4.

FIG. 1 is a front elevation view of a fireplace installation 10 in accordance with one embodiment of the present invention. The illustrated fireplace installation 10 includes a fireplace unit 12 mounted in a fireplace installation accessory unit 14. The fireplace unit 12 of the illustrated embodiment is a self-contained fireplace coupled to an electrical power source 16. In one embodiment, the fireplace unit 12 is an electric fireplace, such as an electric fireplace disclosed in U.S. patent application Ser. No. 11/350,645, entitled Flame Assembly for Fireplace, filed Feb. 8, 2006, which is incorporated in its entirety herein by reference thereto. In other embodiments, the fireplace unit 12 can be a gas-burning fireplace, a wood-burning fireplace, a pellet-burning fireplace, or any other fireplace unit that generates heat and provides fire or simulated fire within the unit, including the fireplace units as disclosed in U.S. Pat. No. 6,953,037, entitled Direct Vent Fireplace Installation, filed Apr. 11, 2003, and U.S. patent application Ser. No. 10/811,068, entitled Fireplace Installation Assembly, filed Mar. 26, 2004, all of which are hereby incorporated in their entireties herein by reference thereto. The fireplace unit 12 fits within the accessory unit 14 and provides an attractive addition to a room 24 or an outside area. Accordingly, the fireplace unit 12 is configured to provide an aesthetically pleasing fire or simulated fire framed by the accessory unit 14, while also heating the room in which the fireplace installation 10 is located.

As illustrated in FIG. 1, the fireplace installation 10 includes a decorative fireplace frame 70 mounted to a front side of the fireplace unit 12 and accessory unit 14. The frame 70 has an opening 72 positioned to allow a person to look into the fireplace unit 12 to see a decorative interior surface 58 and/or a burner assembly 56 that provides the fire. In the embodiment illustrated in FIG. 1, the opening 72 has a partial arcuate shape, and together the frame 70 and the opening 72 have a “portrait” shape such that the height dimensions are greater than the width dimensions. As a result, the tall, thin fireplace unit 12 provides an aesthetically proportioned shape relative to the accessory unit 14 to provide a handsome fireplace installation 10. The fireplace unit 12 is coupled to the power source 16 with a power line 48. The power line 48 can be routed through the accessory unit 14 in a variety of locations to provide the necessary connection to the fireplace unit 12. In certain embodiments, the power source 16 can also provide other sources of power besides electricity. In embodiments wherein the fireplace unit 12 is an electric fireplace, the power source 16 provides electricity to power the lights, heater elements, fans, controls, sensors, and other devices. In one embodiment wherein the fireplace unit 12 is a gas-burning fireplace, the power source 16 provides electricity that can power a fan, timers, controls, lights, and other devices.

The accessory unit 14 illustrated in FIG. 1 is a movable highboy having an upper portion 18 and a lower portion 20. The illustrated accessory unit 14 includes a front side 22 facing the room 24 and a back side 26 (shown in broken lines) configured to correspond to a corner 28 of the room 24. The accessory unit 14 also includes a recess 36 in the front side 22 shaped and sized to receive the fireplace unit 12 so that the fireplace unit is substantially surrounded and framed by the accessory unit 14. The accessory unit 14 is configured to support and contain the fireplace unit 12 in the upper portion 18 above the ground 30. It is to be understood that the ground 30 can be a floor, a foundation, the earth, or other support surface on which the fireplace installation is positioned. The lower portion 20 of the illustrated accessory unit 14 includes a display area 32 for displaying selected items, such as artwork, or the like. In alternate embodiments, the display area 32 can include multiple display areas, shelves, drawers, doors, or other selected features for the decorative furniture unit. One skilled in the art will understand that the display area 32 is not required, but that the display area 32 may improve the aesthetic appearance of the fireplace installation 10 or provide greater flexibility for the use of the space of the lower portion 20. In certain embodiments, the fireplace unit 12 is positioned in the lower portion 20 of the accessory unit 14.

Although the accessory unit 14 of FIG. 1 is a highboy-type structure, other embodiments can include other styles of furniture or other units that receive the fireplace unit 12. For example, the accessory unit 14 can be a housing, a bookcase, an entertainment center, an armoire, a cabinet, a hutch, a dresser, a storage area, a corner-mounted unit, a generally rectangular unit, a rounded or curved display unit, a mantel, or the like. Accordingly, the accessory unit 14 provides a decorative piece that receives and surrounds the fireplace unit 12. The accessory unit 14 can be constructed of a variety of materials, including, but not limited to, wood, pressboard, marble, stone, cement, metal, composite materials, or the like.

The fireplace installation 10 also includes an integral sound system 80 for playing music or other sounds emanating from the fireplace installation 10. The sound system 80 is configured to play music or other recorded sounds through the fireplace installation 10. The illustrated sound system 80 comprises at least the components of an amplifier 82, one or more speakers, and a connector 86. In certain embodiments, a person can connect a music player, such as a portable personal music player, to the sound system to listen to the music player through the fireplace installation 10. One skilled in the art will appreciate that portable music players can include but are not limited to mobile hard drive music players, flash music players, MP3 players, CD players, mobile phones, PDA's and other portable devices capable of playing music. In certain embodiments, the sound system 80 also includes a receiver configured to receive a wireless music signal, such as a radio signal or signal broadcasted from a portable music device. The sound system 80 can also be configured to connect to other audio or visual accessories, in addition to the connector. In other embodiments, the sound system is configured to play common fire sounds, such as sizzling, burning, crackling, flare-ups, or other fire or burning sounds. Accordingly, the fireplace installation 10 can provide a variety of music or sounds and complement the visual experience of the fireplace.

In the embodiment illustrated in FIG. 1, the sound system 80 is positioned in the fireplace installation 10 and is generally not visible to a user. For example, the sound system 80 can be located behind a decorative door or in a concealed compartment (shown in broken lines) in the accessory unit 14. In certain embodiments, the sound system 80 and/or the components of the sound system 80 can be located in different positions throughout the fireplace installation 10. For example, in the embodiment illustrated in FIG. 1, speakers 84 are located in the upper portion 18 of the accessory unit 14. In other embodiments, the speakers can be located in the lower portion, in the sides, or on top of the accessory unit 14. The speakers 84 are at least partially concealed or hidden from view in the accessory unit 14. To at least partially conceal the speakers 84, the speakers 84 are positioned behind a screen, mesh, or other visual obstruction that is integral with the upper portion 18 of the accessory unit 14 that will still allow sound waves to pass through the accessory unit 14. The visual obstruction may blend in with the color, texture, or design of the accessory unit 14. In other embodiments, the speakers 84 may be positioned in a recess or other portion of the accessory unit 14 generally not visible but still open to the room 24. For example, as illustrated in FIG. 1, speakers 85 (shown in broken lines) may be positioned in the lower portion 20 of the accessory unit 14 in a recess in the display area 32. Accordingly, the speakers 85 are not covered with a screen, mesh or other visual obstruction, however the speakers 85 are still positioned at least partially out of view from a person looking at the fireplace installation 10. In other embodiments, the speakers can be concealed or hidden in other portions of the accessory unit 14, such as on top of the accessory unit, which may be out of sight behind molding or other decorative pieces located on top the accessory unit.

In one embodiment, the sound system 80 is powered through the fireplace unit 12. For example, in electric fireplace embodiments, the power source 16 that powers the fireplace unit 12 also powers the sound system 80. Accordingly, the sound system 80 is electrically connected to the fireplace unit 12 so that a user can use a common control system, such as a control panel or a remote controller, to operate the fireplace unit 12 and the sound system 80. In embodiments where the fireplace unit 12 is not electric, the sound system 80 can be connected to a conventional power source.

In one embodiment, the sound system 80 and/or the fireplace unit 12 is configured to be connectable to a remote, independent sound system, such as a sound system in a house or area in which the fireplace installation 10 is installed. In yet another embodiment, the fireplace unit 12 can have a control system that has pre-recorded sound tracks (music or other sounds, such as the sound of a crackling fire or the like), so that when a sound system is connected to the fireplace unit, a user can play those pre-recorded sound tracks.

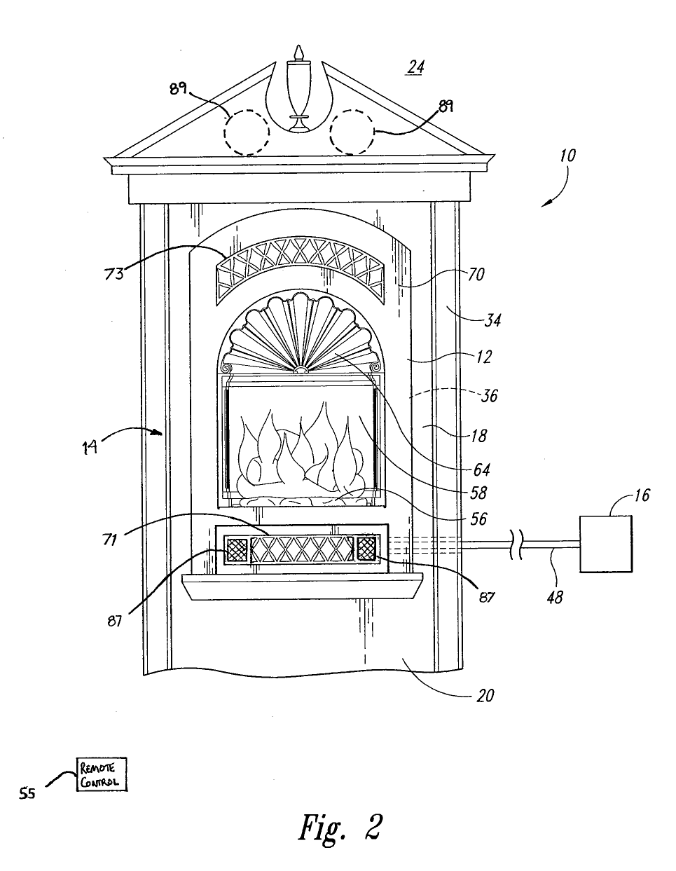

FIG. 2 is a partial front elevation view of a fireplace installation 10 in accordance with another embodiment. Like reference characters refer to like components in FIGS. 2-4 and FIG. 1, and thus the description of such components will not be repeated with reference to FIGS. 2-4. Referring specifically to FIG. 2, the fireplace installation 10 is generally similar to the fireplace installation 10 described above with reference to FIG. 1. In FIG. 2 however, the illustrated fireplace installation 10 includes an accessory unit 14 that is a rectangular cabinet structure configured to be positioned along a flat portion of a wall. The accessory unit 14 of FIG. 2 has an upper portion 18 positioned above the ground (not shown) by a selected distance. The fireplace unit 12 illustrated in FIG. 2 also includes a decorative surface 64. The decorative surface 64 may comprise an interior surface to complement the decorative interior surface 58, or in certain embodiments the decorative surface 64 comprises a cover across the top portion of the fireplace unit 12. The decorative surfaces 58 and 64 have a selected pattern or shape that can be any one of a variety of decorative designs to embellish the fire or simulated fire. In the illustrated embodiment, the decorative surface 64 has a sculpted, shell-type appearance along the quarter-spherical top portion 62. Alternate embodiments can have decorative interior surfaces 58 with designs that simulate bricks, tiles, or a variety of other decorative configurations, such as materials or compositions of materials that change color when a simulated fire or fire is burning in the fireplace unit 12.

The fireplace installation 10 also includes a remote control 55. The remote control 55 is configured to control the fireplace unit 12 and/or the sound system 80. For example, the remote control 55 can turn the fireplace unit 12 on and off, adjust the flame height, or other actual or simulated fire characteristics, turn the sound system 80 on and off, and also control the functionality of the sound system 80, such as stopping and starting music or advancing between songs.

The fireplace installation 10 illustrated in FIG. 2 also illustrates different embodiments for the location of components of the sound system 80. For example, in one embodiment, the fireplace unit 12 includes vents 71 and 73 to facilitate a flow of air around the fireplace unit 12. The vents 71 and 73 allow air to flow around the fireplace unit 12 so that air moving from the room 24 and around the fireplace unit 12 is heated before the air flows back into the room 24 from the fireplace unit 12. In one embodiment, speakers 87 are positioned and at least partially concealed from view in the fireplace unit 12 behind the vent 71 in a location or configuration so the speakers and wires do not get too hot. It will be appreciated that the speakers 87 can also be positioned behind the vent 73. In other embodiments, other components or the entire sound system 80 can be located in the fireplace unit 12. In embodiments where the speakers and/or other components of the sound system are located in the fireplace unit 12, the components will generally be located in areas that are not susceptible to temperatures that would damage the components of the sound system. Alternatively, components located in the fireplace unit 12 can be insulated or shielded to at least partially protect the components from extreme heat.

In another embodiment illustrated in FIG. 2, speakers 89 are located in the upper portion 18 of the accessory unit 14 behind a molding or decorative piece on top of the accessory unit 14. The speakers 89 are generally hidden from view behind the representative decorative piece of the accessory unit 14, however the speakers 89 are not covered or partially enveloped in a mesh or screen material. Accordingly, concealing the speakers 89 without covering them may at least partially improve the audible characteristics of the speakers.

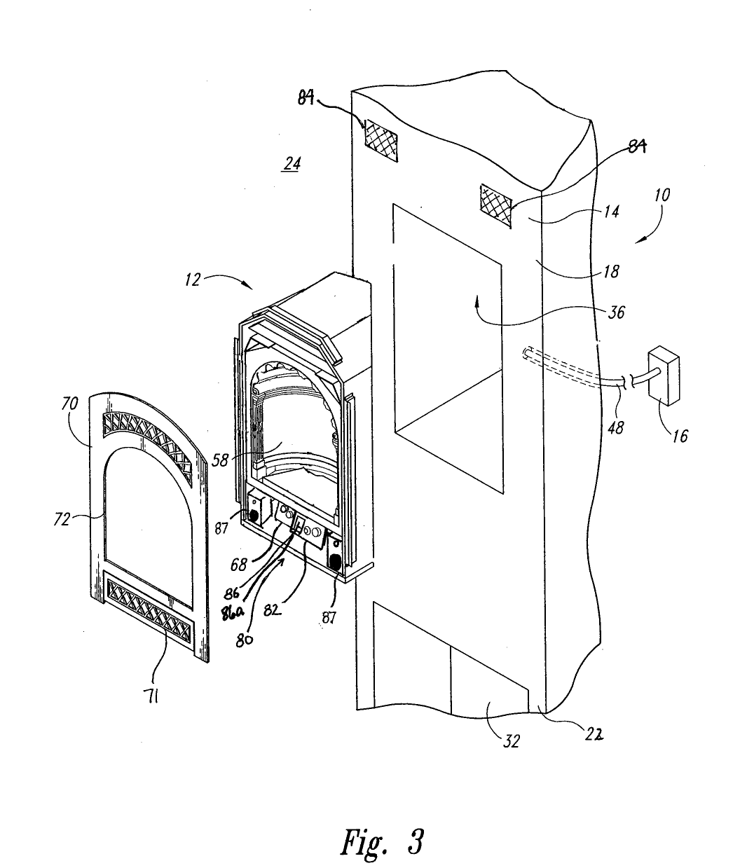

FIG. 3 is an exploded partial isometric view of the fireplace installation 10 similar to the embodiment illustrated in FIG. 1. For example, the accessory unit 14 of FIG. 3 better illustrates the recess 36 in the front side 22 of the upper portion 18 that is configured to receive the fireplace unit 12. In this embodiment, the fireplace unit 12 also includes a compartment housing fireplace controls 68 located behind the vent 71. The fireplace controls 68 allow a user to turn the fireplace unit 12 on and off and to adjust the fire or simulated fire. For example, if the fireplace unit 12 is a gas burning unit, the controls 68 can adjust the amount of gas that is delivered to the fireplace unit 12. The fireplace unit 12 illustrated in FIG. 3 also includes at least one component of the sound system 80 positioned proximate to the fireplace controls 68 behind a decorative panel or door 71 and at least partially out of view. For example, an amplifier 82, connector 86, and speakers 87 are positioned proximate to the fireplace controls 68 behind the door 71, which also acts as an air-inlet vent. The amplifier includes an interface for controlling the sound system 80, such as the power, volume, and functionality of the sound system 80. The connector 86 is configured to dock or receive a portable personal music player 86a, such as an iPod™, an MP3 player, or other device. Still in other embodiments however, the connector 86 may comprise a cable or other connector suitable for different sizes and shapes of music players. In other embodiments as described above, the speakers can be located in the accessory unit 14 rather than the fireplace unit 12. For example, the speakers 84 can be located in the upper portion 18 of the accessory unit 14 while the other components of the sound system 80 are positioned in the fireplace unit 12.

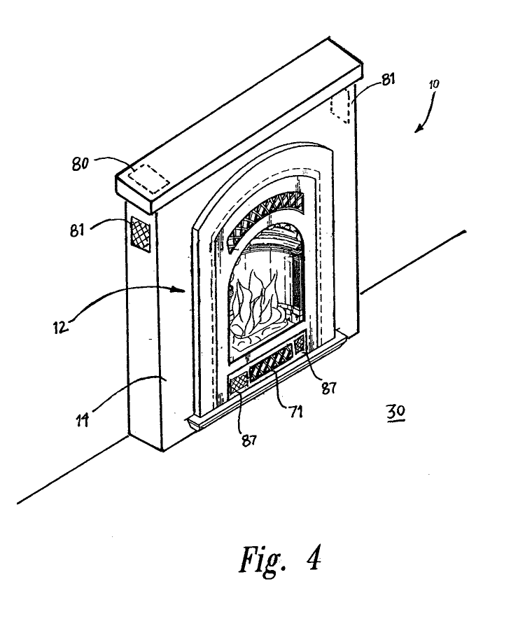

FIG. 4 is an isometric view of a fireplace installation 10 in accordance with another embodiment of the invention. The fireplace unit 12 is generally similar to the fireplace units described above. The accessory unit 14 however is a fireplace mantel and is configured to be positioned along a wall. Accordingly, the fireplace unit 12 is framed or partially surrounded by the mantel. Similar to the embodiments described above, components of the sound system 80 can be located in different positions in the fireplace installation 10. For example the sound system 80 (shown in broken lines) can be positioned and at least partially hidden from view in a compartment in a top portion of the accessory unit 14. In addition, speakers 81 can be positioned and at least partially hidden from view in side portions of the accessory unit 14, or speakers 87 can be positioned behind the screen 71 in the fireplace unit 12. One skilled in the art will appreciate that multiple sets of speakers can be used together to improve the sound quality of the sound system 80.

From the foregoing, it will be appreciated that specific embodiments of the invention have been described herein for purposes of illustration, but that various modifications may be made without deviating from the invention. Furthermore, aspects of the invention described in the context of particular embodiments may be combined or eliminated in other embodiments. Further, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited, except as by the appended claims.

We claim:

1. A fireplace installation, comprising:
a fireplace installation accessory having an opening;
a fireplace unit positioned in the opening; and
a sound system integrally connected to at least one of the fireplace installation accessory and the fireplace unit, wherein the sound system includes at least an amplifier, one or more speakers, and a connector for connecting to a music player.

2. The installation of claim 1 wherein the connector of the sound system comprises a docking station for a portable music device.

3. The installation of claim 1 wherein the fireplace unit comprises an electric fireplace unit coupled to an electrical power source, wherein the electric fireplace unit is configured for displaying a simulated fire.

4. The installation of claim 1 wherein the sound system is powered by the fireplace unit.

5. The installation of claim 1 wherein the sound system further comprises a music player.

6. The installation of claim 1 wherein the sound system is at least partially concealed in at least one of the fireplace installation accessory and the fireplace unit.

7. The installation of claim 1 wherein the one or more speakers of the sound system are mounted on the fireplace installation accessory.

8. The installation of claim 1 wherein the one or more speakers of the sound system are attached to the fireplace unit.

9. The installation of claim 1 wherein the fireplace unit further comprises one or more airflow vents, and wherein at least a portion of the sound system is positioned behind the one or more airflow vents.

10. The installation of claim 1 wherein the fireplace unit further comprises a compartment housing a fireplace control unit, and wherein at least one of the amplifier, one or more speakers, and connector is positioned in the compartment proximate to the fireplace control unit.

11. The installation of claim 1 wherein the fireplace installation accessory is one of a book case, an entertainment center, an armoire, a cabinet, a hutch, a dresser, and a mantel.

12. The installation of claim 1 wherein the fireplace installation accessory is a free standing structure.

13. The installation of claim 1 wherein the fireplace unit is configured for burning gas, wood, pellets or other burnable materials.

14. The installation of claim 1, further comprising a remote control, wherein the remote control is configured to control at least a portion of the sound system.

15. The installation of claim 15 wherein the remote control is configured to control the fireplace unit.

16. A fireplace installation, comprising:
a fireplace installation housing;
a fireplace unit positioned in the fireplace installation housing, wherein at least a portion of the fireplace unit is configured to be powered by an electrical source; and
a sound system configured to play pre-recorded sound tracks, wherein the sound system is integrally connected to at least one of the fireplace installation housing and the fireplace unit, and wherein at least a portion of the sound system is concealed and is powered by the fireplace unit, the sound system including an amplifier, one or more speakers, and a music player connector.

17. The installation of claim 16 wherein the music player connector comprises a docking station for a portable music player.

18. The installation of claim 16 wherein the one or more speakers are mounted on the fireplace installation housing.

19. The installation of claim 16 wherein the one or more speakers are attached to the fireplace unit.

20. The installation of claim 16 wherein the sound system is attached to the fireplace unit, and wherein the sound system is shielded from heat.

21. The installation of claim 16 wherein the fireplace unit is an electric fireplace unit.
